(19) United States
(12) Patent Application Publication
(10) Pub. No.: US 2016/0307561 A1
(43) Pub. Date: Oct. 20, 2016

(54) System for Providing Assistance to the Visually Impaired

(71) Applicants: Lakdas Nanayakkara, Boca Raton, FL (US); Pravin L. Nanayakkara, Boca Raton, FL (US); Anya R. Nanayakkara, Boca Raton, FL (US)

(72) Inventors: Lakdas Nanayakkara, Boca Raton, FL (US); Pravin L. Nanayakkara, Boca Raton, FL (US); Anya R. Nanayakkara, Boca Raton, FL (US)

(21) Appl. No.: 15/131,756

(22) Filed: Apr. 18, 2016

Related U.S. Application Data
(60) Provisional application No. 62/149,181, filed on Apr. 17, 2015.

(51) Int. Cl. G10L 13/04; G06K 9/62

(52) U.S. Cl. CPC G10L 13/043; G06K 9/6267; G06K 9/6201

(57) ABSTRACT

A system for providing assistance to the visually impaired includes: a first image recognition sensor having a first focusing range; a database of images of everyday articles, objects and shapes, each image taken at a distance of about said first focusing range; means for searching and matching an image recognized by said image sensor with an image stored in said database; and an audio chip of an audio database for orally expressing the identity or subject of a first recognized image. The system further includes a second image recognition sensor having a second focusing range; a database of images of everyday articles and shapes, each image taken at a distance of about said second focusing range; means for searching and matching an image recognized by said image sensor at said second range with an image stored in the database of images for said range; and an audio chip of an audio database for orally expressing the identity or subject of an image recognized by the second database. The voice command allows for the user to access the image, audio, GPS, and operational database simultaneously. When the user wishes to identify the object each of these databases will be accessed. If the information cannot be provided the cameras on the glasses will search for the proper operational information. If it cannot be found a signal will be sent requesting a different voice command.

### REFERENCE TO RELATED APPLICATION

This application claims the benefit under 35 USC 119(e) of provisional patent application Ser. No. 62/149,181, filed Apr. 17, 2015, which is incorporated by reference in its entirety.

### BACKGROUND OF THE INVENTION

There has long existed a need in the art to assist the visually impaired, this including not only persons who are entirely blind but, additionally, persons having vision which is impaired to one degree or another, often as a secondary consequence of an otherwise unrelated condition, for example, diabetes. Visual impairments, of varying degrees, can prove troublesome at home, in large complexes or public spaces where individuals will have difficulty recognizing and identifying locations and objects.

There is known in the art electronic systems for embedding within public buildings or workplaces electronics that provide audio signals to warn a visually impaired person when he is approaching a wall, column, internal building intersection of hallways, or a restroom. See for example our U.S. Pat. No. 6,867,697. However, these systems do not furnish any specific identification with respect to most articles, objects, or shapes that the visually impaired person may be approaching or having a reduce capability with respect to different ranges or distances at which such everyday articles, objects and shapes might be approaching the pathway of a user of such systems.

The present invention is therefore an improvement in art of this nature which furnishes to the visually impaired person a capability associated with the eyes such that image recognition within various focus ranges can be preprogrammed into a portable data bank. Articles, objects, shapes, and other information can be programmed into such a system. Voice, images, operational instruction and local positioning of objects at various distances, paired together with a local GPS system, can serve to reference a specific site as an individual is approaching an everyday article, object or shape that might otherwise have proven difficult to be recognized. Such a system thereby provides a far wider range of assistance to those in need thereof than do others, which are known in the art.

### SUMMARY OF THE INVENTION

A system for providing assistance to the visually impaired includes: a voice command operated audio database, visual database, and local gps coordinates with instructional database system with a first image recognition sensor having a first focusing range; a database of images of everyday articles, objects and shapes, each image taken at a distance of about said first focusing range; means for searching and matching an image recognized by said image sensor with an image stored in said database; and an audio chip of an audio database for orally expressing the identity or subject of a recognized image. The system further includes a multiple image recognition sensor having a second focusing range; a database of images of everyday articles and shapes, each image taken at a distance of about said second focusing range; means for searching and matching an image recognized by said image sensor at said second range with an image stored in the database of images for said range; and an audio chip of an audio database for orally expressing the identity or subject of an image recognized by the visual, oral, gps databases.

Each of the image recognition sensors may be provided within a pair of eyeglasses, a visor, hat, or the like, while the audio feedback from the respective voice chips may be provided to the user either via hardwire, or a dedicated frequency, to a earpiece worn by the user. Various levels of sophistication of a single image recognition sensor in combination with a single database may be employed to recognize everyday articles, objects and shapes across a considerable range of distances within a residential, industrial or commercial complex reference to local GPS system specific for the reference structure.

The voice command works with all databases including image, audio, local GPS, and operational system. As soon as the user activates the voice command, each command given will run through each of the databases. If the object cannot be found then each camera will begin searching for the object. If it does recognize then a signal will be sent to the local GPS for turn by turn directions. If it does not recognize, an audio signal will be sent to the earpiece to repeat the voice command in a different format. Once the object has been found the operational system will be activated giving the user detailed information on the object found.

It is accordingly an object of the invention to provide an improved system for assistance of the visually impaired, or a person in an unfamiliar large complex, in which everyday articles from objects and shapes may be recognized over a considerable range of distances and thereupon the identity thereof orally communicated to an earpiece in the ear or ears of the system user with turn by turn direction and instructions on how to operate and carryout the task.

It is another object to afford warnings or alerts to the visually impaired as they may approach everyday articles, objects and shapes or if the same are approaching the individual using the system.

It is a further object to provide a system of the above type capable of recognizing everyday articles and the like, particularly those associated with a user's home or workplace, regardless of the distance from the user that such articles or shapes may be.

It is a yet further object to provide a system turn by turn direction to reach the object with brief operational instructions.

The above and yet other objects and advantages of the present invention will become apparent from the hereinafter set forth Brief Description of the Drawings, Detailed Description of the Invention and Claim appended herewith.

### BRIEF DESCRIPTION OF THE DRAWINGS

FIG. 1 is a block diagrammatic view of the inventive system.

FIG. 2 is a front conceptual view indicating the manner in which the present system, in one embodiment thereof, might appear upon and about the face and ears of a user of the system.

FIG. 3 is a back perspective view of FIG. 2 showing the manner in which the digital hardware associated with the system might be carried within a vest worn by the user.

FIG. 4 is a side view of the illustration of FIG. 3.

The purpose of the Operational Instruction database is to provide the user with step by step instructions. For example if the user walks up to an electric range, they can then activate the service called Instruction Demand which will tell the user where the buttons are to operate the range. In addition to locating key pieces of the range, the Operational database will tell the user how to use the range for various uses.

FIG. 4 is a side view of the illustration of FIG. 3

The transmitter is located within the arms or the frames of the glasses which works with the local GPS and communicates with the individual giving the user turn by turn directional information they need to safely navigate their way through the building complex.

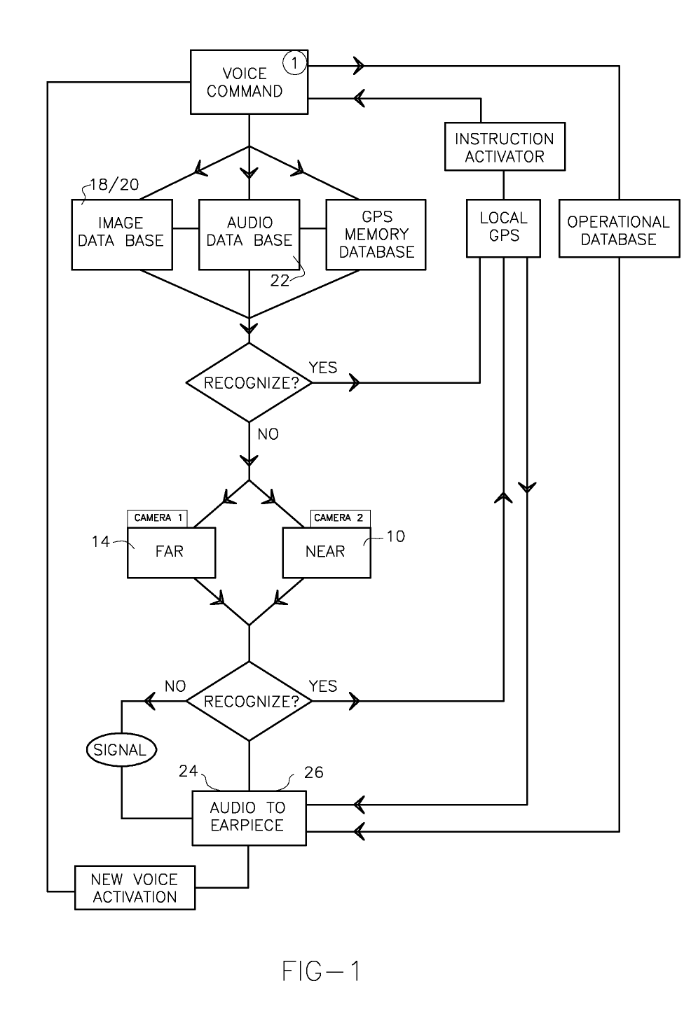

In FIG. 1, the block diagrammatic view entails the following features:

Voice

The voice enabled feature allows for the user to access the preprogramed databank anytime to either identify, locate, or program the device. This voice enabled system brings the devices many features together. All features work together, but the voice enabled system really ties them together. If the user wishes to identify an object near them, they simply ask the device to identify the object and then that information is then relayed through the earpieces back to the user.

Images

This feature of the device allows for instant recognition of objects within a given distance. The purpose of this feature is to provide the user with recognition of any object, pen, refrigerator, clothing, couch, etc. This recognition system works off a preprogramed data bank which will contain images of items such as those mentioned above. These programmed images allows for more fluid recognition of items the cameras capture. Images can be programmed into the system by the user to allow for more specialized uses.

Audio

The audio feature of this device allows for sounds to be received and transmitted to the user through the headphones. The purpose is to allow the user to hear the sounds occurring around them. Audio can also be programmed into the device, to allow the user to begin to link image recognition to sound.

Local GPS

The Local GPS system is unlike the GPS system we are accustomed to. This system creates and operates on a virtual 3D map of the user's home. This will allow for the user to locate any object in the house at any instant by utilizing the voice feature. For instance, if the user wanted locate the kettle, they would simply say kettle and then the device would quickly access its 3d map and then provide turn by turn directions to the user with the purpose of locating the object. The device works by bringing all the features together to convey information from the environment to the user. The device should allow for the user to use at home or in the workplace and be able to identify, locate and program anything they may encounter. The device should be sharp enough to capture real time pictures which can be compared and added to their databank for future. This will allow for the user to adapt their device to their own specific needs. The local GPS will aid in locating objects and places important to the user.

An example of this is if the user arrives home and uses the voice command for a can opener, this message goes to the audio, image, and GPS databank. If the device recognizes the item, the local GPS is activated and give turn by turn directions. If the object cannot be found in the local GPS, camera1 and camera 2 will search for the item to match with the image databank. Once recognized it will access the local GPS, giving the user turn by turn directions. If the cameras cannot recognize the objects it will send a message to the earpiece stating that it cannot identify the object. The user can then give a different voice command for the same object. Once, the object is located the user can then save this image to the databank.

### Operational System

Once the object has been recognized the operational databank sends an audio command to the earpiece of step by step operational instructions to operate the selected object. For example the operation of a microwave.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

### DETAILED DESCRIPTION OF THE INVENTION

The voice command allows for the user to access the image, audio, GPS, and operational database simultaneously. When the user wishes to identify the object each of these databases will be accessed. If the information cannot be provided the cameras on the glasses will search for the proper operational information. If it cannot be found a signal will be sent requesting a different voice command.

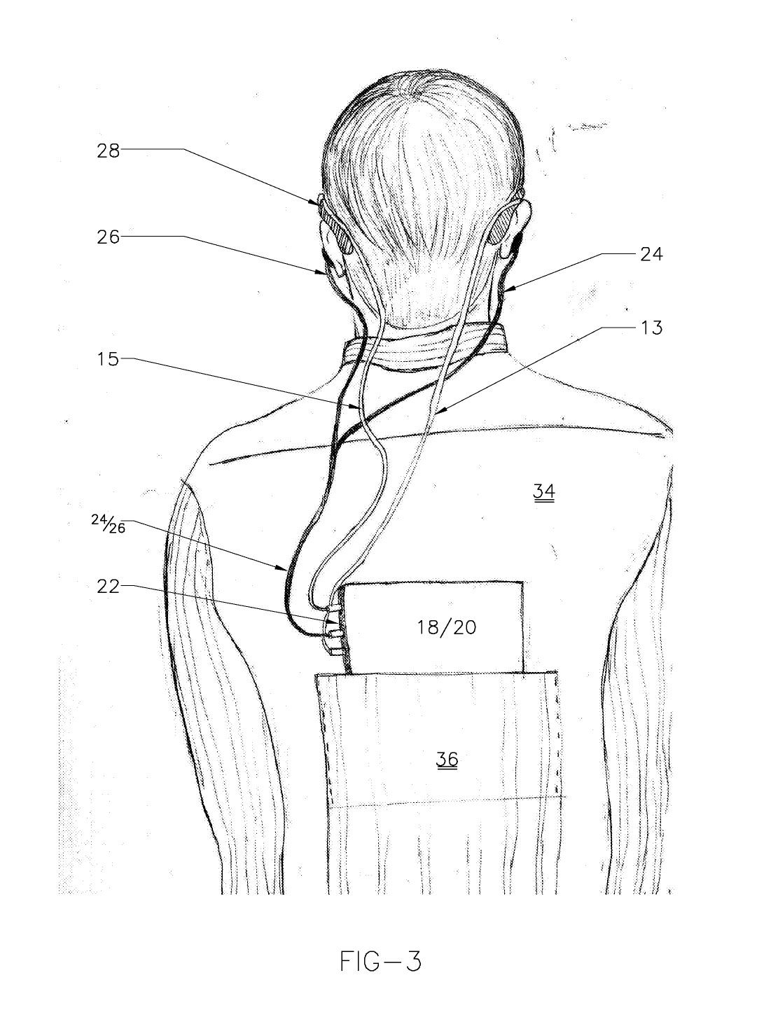

With reference to the block diagrammatic view of FIG. 1, the present system, in one embodiment thereof, may be seen to include a first image recognition sensor, in the nature of a camera 10, in a focus range which may be defined in either digital or analog terms, for example, such first range may comprise a specific distance, i.e., 5 feet or, in the analog mode, may cover all closer distances as, for example, in the range of zero to ten feet. Similarly, the sensor or camera 14 shown in FIG. 1 may have a specific range, for example, twenty feet or may operate on an analog basis within a range of about two to about 25 feet. Clearly, analog recognition over such ranges and distances, constitute and require a higher level of sophistication with respect to the databases, described below, than do that of recognition of objects, articles and the like at discreet specific distances. However, in any of the above embodiments, the information acquired by sensors 10 and 14 respectively must be digitized, which function is indicated conceptually at blocks 12 with respect to sensor 10 and block 16 with respect to sensor 14, in FIGS. 1 and 3. Therefrom, the shorter distance data, whether of a digital or analog nature, communicates through link 13 to a shorter distance database 18, while longer range data, whether digital or analog in nature, is provided through link 15 to image database 20.

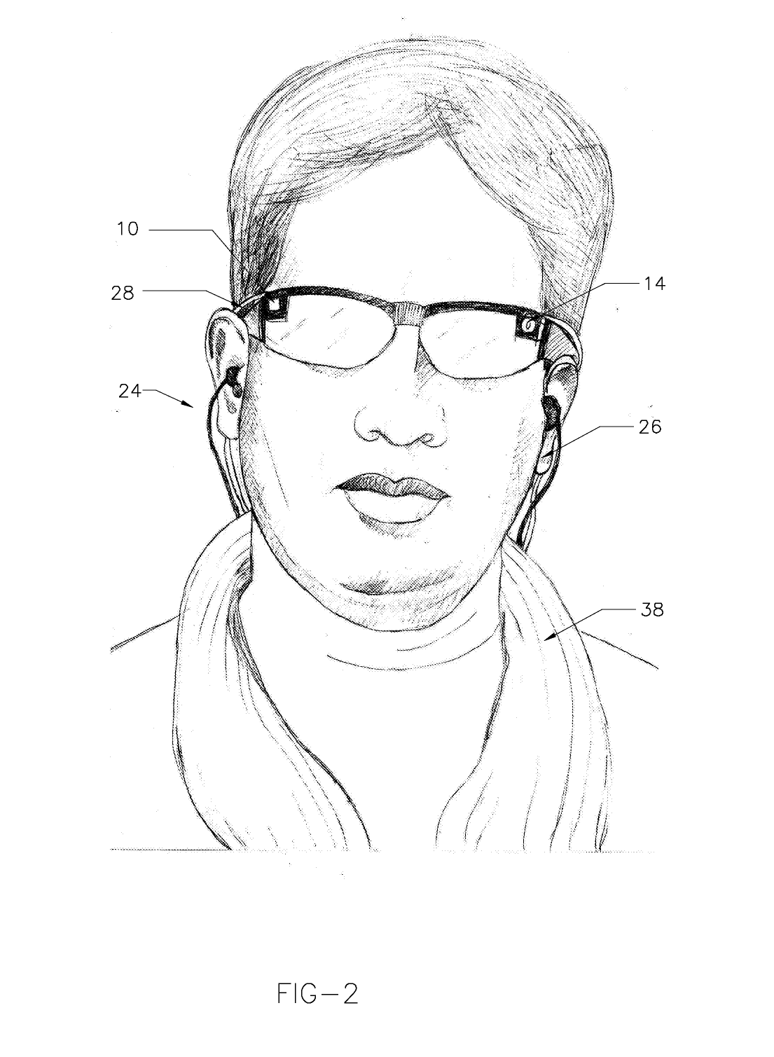

It is to be appreciated that, as a step in the production of the present system, image databases 18 and 20 must be programmed with respect to a given number of everyday articles, objects, and shapes, likely to be encountered by a system user within his home, workplace or a neighborhood within which he lives or works, or one which he may commonly frequent, for example, a shopping mall or the like. As such, it is necessary to pre-program image databases 18 and 20 for such a variety of articles, objects and shapes, perhaps requiring on the order of 500,000 such objects, and as the same might be recognized at a range of up to 25 feet or any distance with 360 degrees of camera coverage. In other words, a single object, might require entries in close image database 18 and three entries in the far image database 20 to provide an appropriate spectrum of possible images for a particular article, object or shape to be identified by database 18 or 20 which, in turn, is communicated, through link 21 to an audio database 22. See FIG. 1. A dynamic re-check 23, also shown, may modify given that the response of database 18 or 20 if the user continues to move within a given area or space which is important to be continually re-checked for the selected articles, objects and shapes such that similarly shaped objects will not be confused with each other as the user moves about a given area or space. The output of audio database 22 is then provided to respective earpieces 24 and 26 (see FIG. 2) of the user. However, it is to be understood, that such outputs may easily be integrated into a single earpiece and provided to the user in which the audio output 24 versus that of 26 is differentiated simply by the tone of voice or, for example, the gender of the voice emanating from audio database 22.

The present system also provides for an archives 25 of database selections such that a record of the most commonly recognized articles, objects and shapes may be maintained in archives 25 to reduce the operating bandwidth along arrow, this as indicated by arrow going from archives to audio database 22 to see if it can recognize inputs as a common, often repeated images and therefrom, feed the information directly through the audio database 22 such that only the less frequently encountered images would require processing through image databases 18 and 20.

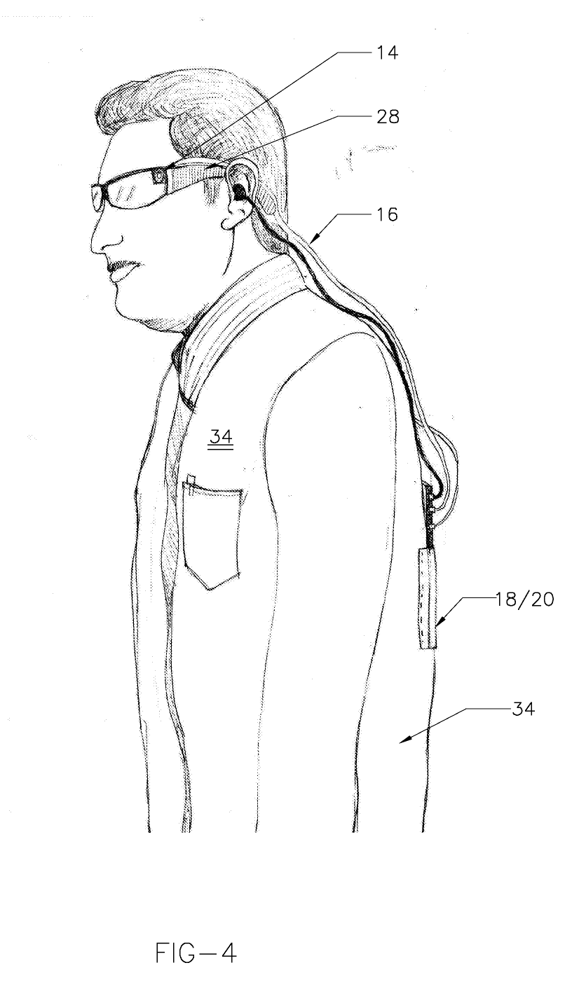

In FIGS. 2 and 4 are shown the location of sensors 10 and 14 embedded in the corner of eyeglasses of a system user. It is however to be appreciated that eyeglasses represent but one expedient for the positioning of sensors 10 and 14. For example, said sensors could be placed within a visor or conceivably upon a scarf 30 or other article including a vest (see FIG. 4). Such an article of clothing 34 may, as indicated in FIGS. 3 and 4, include a pocket which would hold the hardware of the system, principally, databases 18, 20, and 22.

Given state of the art integrated circuit methods, the ultimate system may employ micro-processors and be much smaller than is shown in FIG. 3, and might fit within eye frame 28.

We claim:

1. A system for providing assistance to the visually handicapped and person in a large commercial, industrial voice command recognize of pre recorded image, audio, location and direction and operation instruction sensor built into a single system.

2. The system as recited in claim 1 has option command for operational instruction

3. The system as recited in claim, has warning that object was not recognized through the process and allow to re format the voice command.

4. The system as recited in claim 1 has multiple audio tones for turn by turn direction, instructions and reformat the voice command.

5. The system as recited in claim 1 has input options of additional pre recorded data for each specific site via stream down loading, sim card.

6. The system as recited in claim 1 has two arms of the eyeglasses where the transponders are located, representing the receiver of the local GPS information.

7. A system for providing assistance to the visually impaired, comprising:
(a) a first image recognition sensor having a first focus range;
(b) a database of images of everyday articles and shapes, each image taken at a distance of about said first focus range;
(c) means for searching and matching an image recognized by said image sensor with an image stored in said database; and
(d) an audio chip of an audio database for orally expressing the identity or subject of a recognized image.

8. The system as recited in claim 1 further comprising:
(e) a second image recognition sensor having a second focus range;
(f) a database of images of everyday articles and shapes, each image taken at a distance of about said second focus range;
(g) means for searching and matching an image recognized by said image sensor (e) with an image stored in said database (f);
(h) a voice chip for orally expressing the identity or subject of a recognized image of means (g).

9. The system as recited in claim 2, in which an expression of each audio chip comprises an advisory of a distance to the article recognized.

10. The system as recited in claim 3, further comprising said image recognition sensors included within an eyeglass frame, hat, cap, and helmet.

11. The system as recited in claim 3, further comprising said audio chip embedded within an earpiece.

12. The system as recited in claim 4, further comprising said audio chip embedded within an earpiece.

13. The system as recited in claim 4, in which an expression of each audio chip comprises an advisory of a distance to the article recognized.

14. The system as recited in claim 4, in which an expression of each audio chip comprises an advisory of a distance to the article recognized.

15. The system as recited in claim 3 in which said first range comprises about 2 to 25 feet.

16. The system as recited in claim 9, in which said second range comprises about 25 to 50 feet.

17. The system as recited in claim 4 in which said first range comprises about 5 feet.

18. The system as recited in claim 11, in which said second range comprises about 20 feet.

19. The system as recited in claim 3, further comprising:
Said image recognition sensors included within a visor.

20. The system as recited in claim 3, in which said first focus range comprises zero to ten feet.

21. The system as recited in claim 14, in which said second focus range comprises ten to 25 feet.

21. The system as recited in claim 15, in which said second focus range comprises ten to 25 feet.

22. The system as recited in claim 1 in which said image, audio, operational instructional system and databases reside within a microprocessor.
